(19) United States
(12) Patent Application Publication
(10) Pub. No.: US 2017/0160732 A1
(43) Pub. Date: Jun. 8, 2017

(54) REMOTE DIAGNOSIS SYSTEM AND METHOD FOR OPERATING THE SAME

(71) Applicant: DARTPOINT TECH. CO., LTD., TAIPEI CITY (TW)

(72) Inventors: Chi-Lin KANG, NEW TAIPEI CITY (TW); Chao-Yuan HUANG, TAIPEI CITY (TW)

(21) Appl. No.: 15/292,154

(22) Filed: Oct. 13, 2016

Related U.S. Application Data
(60) Provisional application No. 62/264,345, filed on Dec. 8, 2015.

(30) Foreign Application Priority Data
May 31, 2016 (TW) 105117080

(51) Int. Cl. G05B 23/02; A61H 33/00

(52) U.S. Cl. CPC G05B 23/0259; A61H 33/005; A61H 2201/50; G05B 2219/14084

(57) ABSTRACT

A remote diagnosis system is introduced herein, which is applied to at least one spa bathing equipment. The remote diagnosis system comprises a spa bathing system and a remote operating platform. The spa bathing system comprises a plurality of devices for actuating relatively to the spa bathing equipment, and a spa bathing control unit having a control unit for controlling actuations of the plurality of devices, which is used to correspondingly generate at least one partial-region information according to at least one partial-region status generated by the spa bathing system, and to actively or passively transmit the at least one partial-region information toward outside the spa bathing system.

### CROSS-REFERENCE TO RELATED APPLICATIONS

This application claims the benefits of Taiwan Patent Application No. 105117080 filed on May 31, 2016; U.S. Provisional Patent Application No. 62/264,5345 filed on Dec. 8, 2015, the contents of which are incorporated herein by reference in their entirety.

### FIELD OF THE INVENTION

The present invention relates to a remote diagnosis system and a method for operating the same, and in particularly to, a remote diagnosis system and a method thereof is related to the technical field applied to SPA bathing equipment such as massage bathtubs and spa pools.

### BACKGROUND OF THE INVENTION

A conventional diagnosis method for a spa bathing system is that: first, a rough all-region detection is performed on the whole spa bathing system so as to derive a present total current value drawn by the whole spa bathing system or a present total input power value consumed by the whole spa bathing system. Then, the present total current value (or the present total input power value) is compared with a preset total current value (or a preset total input power value) in difference/a range. According to the compared result, the present total current value (or the present total input power value) is determined normal or abnormal. As long as the result is determined abnormal, a next fine partial-region detection is performed on a plurality of devices disposed within the spa bathing system, so as to respectively detect a plurality of current values or a plurality of power values from the detected devices (such as a heater, an ozone generator, a ultraviolet light generator, a pump, a blower . . . ). Finally, it is determined whether any one of the detected devices is abnormal according to the respective current value or the respective power value corresponding to the respective device, so as to fix, replace or maintain the detected device(s).

However, the conventional diagnosis method has the following disadvantages:

1. Actually the spa bathing system is being abnormal but a result of calculating the present total current value or the present total input power is determined normal. The reason may be that one of the devices (or multiple of the devices) is abnormal with a higher individual current value (or a higher individual power value) but at the same time another device (or another multiple devices) is also abnormal with a lower individual current value (or a lower individual power value), such that a sum of the higher individual current value (or the higher individual power value) and the lower individual current value (or the individual power value) is balanced as a normal total current value (or a normal total power value). However, such a balanced-normal total current value (or a normal total power value) cannot discover a potential abnormal in the spa bathing system.

2. The conventional diagnosis method needs to detect the present total current value (or the present total power value) of the whole spa bathing system so as to determine whether the present total current value (or the present total power value) is abnormal or not. Next, the plurality of current values (or the plurality of power values) with reference to the plurality of devices are detected, so as to further determine whether the plurality of current values (or the plurality of power values) are abnormal or not. Thus, it needs to take a much longer detection time for the whole spa bathing system and the plurality of devices.

Hence, it is needed to provide an innovative remote diagnosis system and a method for operating the same.

### SUMMARY OF THE INVENTION

In order to solve the problem of the prior art, an inventive objective of the present invention is to provide a remote diagnosis system, which is applied to at least one spa bathing equipment, so as to avoid a balanced-normal total current value (or a normal total power value) which may lead to a potential abnormal of the spa bathing system, and to greatly reduce a detection time by simplifying a detection process and performing less steps of the method.

In the present invention, the remote diagnosis system comprises a spa bathing system and a remote operating platform. The spa bathing system comprises a plurality of devices and a spa bathing control unit. The plurality of devices are used to actuate relatively to the spa bathing equipment. The spa bathing control unit comprises a control unit that is used to control actuations of the plurality of devices, correspondingly generate at least one partial-region information according to at least one partial-region status generated by the spa bathing system, and to actively or passively transmit the at least one partial-region information toward outside the spa bathing system.

The remote operating platform is connected with the spa bathing control unit to receive the at least one partial-region information via a network unit,. The remote operating platform comprises a user operation interface correspond with the at least one partial-region information, to selectively generate at least one diagnosis control that makes the control unit to perform at least one automatic detection process on a single attached device and/or multiple attached devices included within the plurality of devices, based on the at least one selected diagnosis control.

In a preferred embodiment, the remote operating platform is one of a pad, a mobile phone, a notebook, a desktop, a server or any electronic device having a microprocessor.

In a preferred embodiment, the plurality of devices comprises at least one attached device, which performs actuations relative to the spa bathing equipment, the at least one partial-region status contains a working status of the at least one attached device, and the at least one partial-region information contains a working information of the at least one attached device.

In a preferred embodiment, the control unit is used to control the at least one attached device, for further controlling the working status of the at least one attached device.

In a preferred embodiment, the plurality of devices further comprises at least one sensor which is electrically connected with the control unit and is used to detect either a physical measurement value or a chemical measurement value with reference to the at least one attached device, to make that the at least one partial-region information contains either the physical measurement value or the chemical measurement value with reference to the at least one attached device.

In a preferred embodiment, the remote operating platform makes the control unit selectively performing the automatic detection process of the single attached device and/or the automatic detection process of the multiple attached devices, directly based on the at least one partial-region information.

In a preferred embodiment, the spa bathing control unit further comprises a detection feedback device, which is used to be electrically connected with the control unit and the at least one attached device, the detection feedback device further comprises at least one sensor and at least one switch controlled by the control unit, the at least one sensor is used to detect either a physical measurement value or a chemical measurement value with reference to the at least one attached device, to make that the at least one partial-region information contains the physical measurement value or the chemical measurement value with reference to the at least one attached device.

In a preferred embodiment, the remote operating platform makes the control unit and the detection feedback device selectively performing the automatic detection process of the single attached device and/or the automatic detection process of the multiple attached devices, directly based on the at least one partial-region information.

In a preferred embodiment, the spa bathing system further comprises a power source, which is used to supply power for operation of the spa bathing system.

In a preferred embodiment, the plurality of devices further comprise a light controller.

In a preferred embodiment, the at least one attached device comprises at least one or a combination of a heater, an ozone generator, an ultraviolet light generator, a pump, and a blower.

In a preferred embodiment, the remote operating platform further comprises a storage device and a managing unit. The storage device is used to store at least one reference value and the at least one partial-region information. The managing unit is used to perform the automatic detection process of the single attached device and/or the automatic detection process of the multiple attached devices, directly based on the at least one reference value and the at least one partial-region information.

In a preferred embodiment, the remote diagnosis system further comprises an external storage and/or an internet/intranet storage equipment.

In a preferred embodiment, at least one of the external storage, the internet/intranet storage equipment, and the remote operating platform is used to store at least one of a result of the at least one automatic detection process and an identification code with reference to the at least one spa bathing equipment.

In a preferred embodiment, the control unit correspondingly generates the at least one partial-region information, according to the at least one partial-region status generated by at least one of the plurality of devices and/or the spa bathing control unit, the at least one partial-region information is different from an information based on an input power supplied for the whole spa bathing system.

In a preferred embodiment, the remote operating platform is connected with the spa bathing control unit through wired or wireless connection.

In order to solve the problem, the present invention provides another remote diagnosis system, which is applied to at least one spa bathing equipment. The remote diagnosis system comprises at least one spa bathing system, a user operation interface, and a remote operating platform.

Each of the spa bathing system comprises a plurality of devices and a spa bathing control unit. The plurality of devices are used to actuate relatively to the spa bathing equipment. The spa bathing control unit comprises a control unit which is used to control actuations of the plurality of devices, correspondingly generate at least one partial-region information according to at least one partial-region status generated by the spa bathing system, and actively or passively transmit the at least one partial-region information toward outside the spa bathing system.

The user operation interface is used to generate at least one preset operating schedule that comprises at least one diagnosis control.

The remote operating platform connects with the spa bathing control unit to receive the at least one partial-region information via a network unit, performing the at least one preset operating schedule, and the control unit is requested to perform at least one automatic detection process on a single attached device and/or multiple attached devices included within the plurality of devices, based on the at least one diagnosis control.

In a preferred embodiment, the remote operating platform is one of a pad, a mobile phone, a notebook, a desktop, a server, or any electronic device comprising a microprocessor.

In a preferred embodiment, the plurality of devices comprises at least one attached device, which performs actuations relatively to the spa bathing equipment, the at least one partial-region status contains a working status of the at least one attached device, and the at least one partial-region information contains a working information of the at least one attached device.

In a preferred embodiment, the control unit is used to control the at least one attached device for further controlling the working status of the at least one attached device.

In a preferred embodiment, the plurality of devices further comprises at least one sensor which is electrically connected with the control unit and is used to detect either a physical measurement value or a chemical measurement value with reference to the at least one attached device, to make the at least one partial-region information contains either the physical measurement value or the chemical measurement value with reference to the at least one attached device.

In a preferred embodiment, the remote operating platform makes the control unit selectively performing the automatic detection process of the single attached device and/or the automatic detection process of the multiple attached devices, directly based on the at least one partial-region information.

In a preferred embodiment, the spa bathing control unit further comprises a detection feedback device, which is electrically connected with the control unit and the at least one attached device, and comprises at least one sensor and at least one switch controlled by the control unit, the at least one sensor is used to detect either a physical measurement value or the chemical measurement value with reference to the at least one attached device, to make that the at least one partial-region information contains the physical measurement value or the chemical measurement value with reference to the at least one attached device.

In a preferred embodiment, the remote operating platform makes the control unit and the detection feedback device selectively performing the automatic detection process of the single attached device and/or the automatic detection process of the multiple attached devices on the at least one attached device, directly based on the at least one partial-region information.

In a preferred embodiment, the spa bathing system further comprises a power source, which is used to supply power for operation of the spa bathing system.

In a preferred embodiment, the plurality of devices further comprise a light controller.

In a preferred embodiment, the at least one attached device comprises at least one or a combination of a heater, an ozone generator, an ultraviolet light generator, a pump, and a blower.

In a preferred embodiment, the remote operating platform further comprises a storage device and a managing unit. The storage device is used to store at least one reference value and the at least one partial-region information. The managing unit is used to perform the automatic detection process of the single attached device and/or the automatic detection process of the multiple attached devices, directly based on the at least one reference value and the at least one partial-region information.

In a preferred embodiment, the remote diagnosis system further comprises an external storage and/or an internet/intranet storage equipment.

In a preferred embodiment, at least one of the external storage, the internet/intranet storage equipment, and the remote operating platform is used to store at least one of a result of the at least one automatic detection process, an identification code with reference to the at least one spa bathing equipment and the at least one preset operating schedule.

In a preferred embodiment, the control unit correspondingly generates the at least one partial-region information, according to the at least one partial-region status of the at least one device of the plurality of devices and/or the spa bathing control unit, the at least one partial-region information is different from an information based on an input power supplied for the whole spa bathing system.

In a preferred embodiment, the remote operating platform is connected with the spa bathing control unit through wired or wireless connection.

In a preferred embodiment, the at least one preset operating schedule contains a processing schedule and the automatic detection process, of the at least one spa bathing system.

In a preferred embodiment, a format of the at least one preset operating schedule is one of a relational database, a non-relational databases, a text file, a spreadsheet, a format similar to the spreadsheet, and a computer-recognized data.

In a preferred embodiment, the remote diagnosis system further comprises an operational terminal, which is used to connect with the remote operating platform through wired or wireless connection, and the user operation interface is disposed on the operational terminal.

In a preferred embodiment, the user operation interface is disposed on the remote operating platform.

In order to solve the problem, the present invention provides another remote diagnosis system, which is applied to at least one spa bathing equipment. The remote diagnosis system comprises a spa bathing system, a user operation interface, and a remote operating platform.

The spa bathing system comprises a plurality of devices and a spa bathing control unit. The plurality of devices are used to actuate relatively to the spa bathing equipment. The spa bathing control unit comprises a control unit which is used to control actuations of the plurality of devices.

The user operation interface is used to selectively generate at least one diagnosis control.

The remote operating platform is connected with the spa bathing control unit via a network unit, making the control unit to perform at least one automatic detection process on a single attached device and/or multiple attached devices included within the plurality of devices, based on the at least one diagnosis control.

In a preferred embodiment, the control unit is used to correspondingly generate at least one partial-region information according to at least one partial-region status generated by the spa bathing system, and actively or passively transmit the at least one partial-region information toward outside the spa bathing system.

In order to solve the problem, the present invention provides another remote diagnosis system, which is applied to at least one spa bathing equipment, The remote diagnosis system comprises at least one spa bathing system and a remote operating platform.

Each of the spa bathing system comprises a plurality of devices and a spa bathing control unit, The plurality of devices are used to actuate relatively to the spa bathing equipment, The spa bathing control unit comprises a control unit which is used to control actuations of the plurality of devices.

The remote operating platform is connected with the spa bathing control unit via a network unit, performing at least one preset operating schedule which contains at least one diagnosis control that makes the control unit to perform at least one automatic detection process on a single attached device and/or multiple attached devices included within the plurality of devices, based on the at least one diagnosis control.

In order to solve the problem, the present invention provides an operating method for a remote diagnosis system, which comprises: first, it is verified whether an identification code with reference to the at least one spa bathing equipment is valid or not; then, when the identification code is verified to be valid, a networking connection between a remote operating platform and a spa bathing system corresponding to the at least one spa bathing equipment is established; then, at least one partial-region information generated by a spa bathing system is received when the networking connection is established successfully by the remote operating platform; then, at least one diagnosis control is selectively generated by using a user operation interface corresponding to the at least one partial-region information; finally, the spa bathing system is requested to perform at least one automatic detection process on a single attached device and/or multiple attached devices which are disposed within the spa bathing system, based on the at least one diagnosis control.

In a preferred embodiment, the automatic detection process performed on the single attached device comprises: first, one of all of the plurality of attached devices is turned on and the rest of the plurality of attached devices are turned off by a spa bathing control unit disposed within the spa bathing system; then, at least one partial-region information is generated according to at least one partial-region status of the respective attached devices and the at least one partial-region information is actively or passively transmitted to the remote operating platform by using the spa bathing control unit; finally, a report is generated according to the at least one partial-region information by the remote operating platform.

In a preferred embodiment, the automatic detection process performed on the single attached device further comprises: information contained within the report is transmitted to a user terminal.

In a preferred embodiment, the automatic detection process performed on the multiple attached devices comprises: first, step (1), all of a plurality of attached devices are turned off by using a spa bathing control unit disposed within the spa bathing system; then, step (2), a first partial-region information is generated according to a first partial-region status of the respective attached devices and the first partial-region information is actively or passively transmitted to the remote operating platform by using the spa bathing control unit; then, step (3), one of all of the attached devices is turned on by using the spa bathing control unit, according to a preset sequence; then, step (4), a second partial-region information is generated according to a second partial-region status of the turned-on attached device and the second partial-region information is actively or passively transmitted to the remote operating platform by the spa bathing control unit; then, step (5), the turned-on attached device is turned off according to the preset sequence by using the spa bathing control unit; then, step (6), a third partial-region information is generated according to a third partial-region status of the attached device which is turned on and then turned off, and the third partial-region information is actively or passively transmitted to the remote operating platform by using the spa bathing control unit; then, step (7), the step (3) to the step (6) are performed for the rest of the attached devices according to the preset sequence; finally, step (8), a report is generated according to the respective partial-region information by the remote operating platform.

In a preferred embodiment, the automatic detection process performed on the multiple attached devices further comprises: information contained within the report is transmitted to a user terminal.

In order to solve the problem, the present invention provides an operating method for a remote diagnosis system, which comprises: first, at least one preset operating schedule is received by using a user operation interface, the at least one preset operating schedule comprises at least one diagnosis control and an identification code with reference to the at least one spa bathing equipment; then, it is verified whether the identification code is valid or not; then, when the identification code is verified to be valid, a networking connection between a remote operating platform and a spa bathing system corresponding to the at least one spa bathing equipment is established; then, when the networking connection is established successfully, at least one preset operating schedule is performed by the remote operating platform; finally, the spa bathing system is requested to perform at least one automatic detection process on a single attached device and/or multiple attached devices which are disposed within the spa bathing system, based on the at least one diagnosis control.

In a preferred embodiment, the automatic detection process performed on the single attached device comprises: first, one of all of the plurality of attached devices is turned on and the rest of the plurality of attached devices are turned off by a spa bathing control unit disposed within the spa bathing system; then, at least one partial-region information is generated according to at least one partial-region status of the respective attached devices and the at least one partial-region information is actively or passively transmitted to the remote operating platform by using the spa bathing control unit; finally, a report is generated according to the at least one partial-region information by the remote operating platform.

In a preferred embodiment, the automatic detection process performed on the single attached device further comprises: information contained within the report is transmitted to a user terminal.

In a preferred embodiment, the automatic detection process performed on the multiple attached devices comprises: first, step (1), all of a plurality of attached devices are turned off by using a spa bathing control unit disposed within the spa bathing system: then, step (2), a first partial-region information is generated according to a first partial-region status of the respective attached devices and the first partial-region information is actively or passively transmitted to the remote operating platform by using the spa bathing control unit; then, step (3), one of all of the attached devices is turned on by using the spa bathing control unit, according to a preset sequence; then, step (4), a second partial-region information is generated according to a second partial-region status of the turned-on attached device and the second partial-region information is actively or passively transmitted to the remote operating platform by the spa bathing control unit; then, step (5), the turned-on attached device is turned off according to the preset sequence by using the spa bathing control unit: then, step (6), a third partial-region information is generated according to a third partial-region status of the attached device which is turned on and then turned off, and the third partial-region information is actively or passively transmitted to the remote operating platform by using the spa bathing control unit; then, step (7), the step (3) to the step (6) are performed for the rest of the attached devices according to the preset sequence; finally, step (8), a report is generated according to the respective partial-region information by the remote operating platform.

In a preferred embodiment, the automatic detection process performed on the multiple attached devices further comprises: information contained within the report is transmitted to a user terminal.

Compared with the prior art, the present invention directly and respectively detects the plurality of currents or powers corresponding to the plurality of attached devices of the spa bathing equipment, which is able to prevent the recessive-abnormal problem, to decrease the maintenance cost and detection time of the spa bathing equipment.

### DESCRIPTION OF THE DRAWINGS

FIG. 1 is an architectural schematic view of a remote diagnosis system according to a first preferred embodiment of the present invention:

FIG. 2 is an architectural schematic view of a remote diagnosis system according to a second preferred embodiment of the present invention;

FIG. 3 is an architectural schematic view of a remote diagnosis system according to a third preferred embodiment of the present invention;

FIG. 4 is an architectural schematic view of a remote diagnosis system according to a fourth preferred embodiment of the present invention;

FIG. 5 is an architectural schematic view of a remote diagnosis system according to a fifth preferred embodiment of the present invention;

FIG. 6 is a flowchart of an operating method for a remote diagnosis system according to a first preferred embodiment of the present invention;

FIG. 7 is a detailed flowchart of the automatic detection process on the single attached device of FIG. 6;

FIG. 8 is a detailed flowchart of the automatic detection process on the multiple attached devices of FIG. 6; and

FIG. 9 is a flowchart of an operating method for a remote diagnosis system according to a second preferred embodiment of the present invention.

### DETAILED DESCRIPTION OF THE PREFERRED EMBODIMENTS

This description of the exemplary embodiments is intended to be read in connection with the accompanying drawings, which are to be considered part of the entire written description. In the description, relative terms such as “lower”, “upper”, “horizontal”, “vertical”, “above”, “below”, “up”, “down”, “top”, and “bottom”, as well as derivatives thereof (e.g., “horizontally”, “downwardly”, “upwardly”, etc.) should be construed to refer to the orientation as then described or as shown in the drawing under discussion. These relative terms are for convenience of description and do not require that the apparatus be constructed or operated in a particular orientation, and do not limit the scope of the invention.

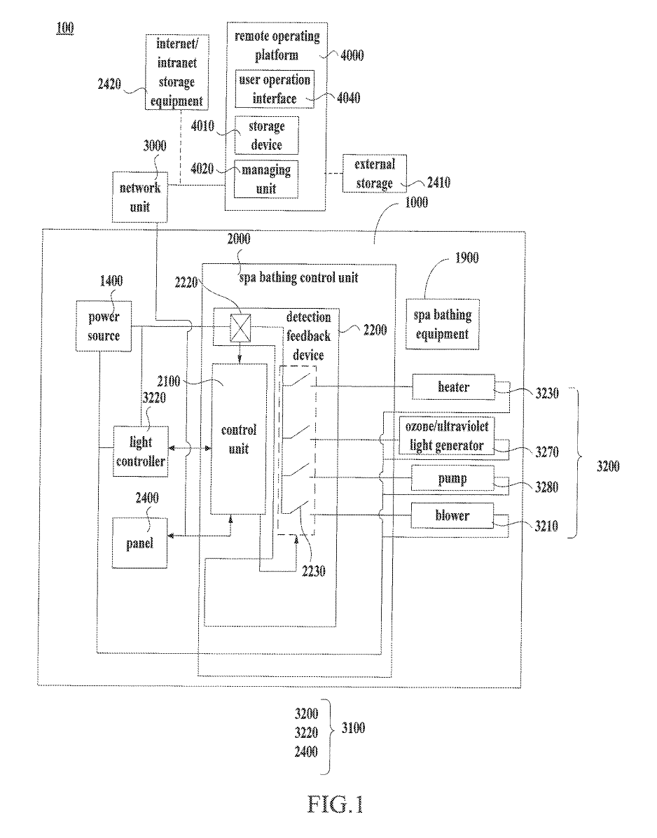

FIG. 1 is an architectural schematic view of a remote diagnosis system 100 according to a first preferred embodiment of the present invention. The remote diagnosis system 100 is applied to at least one spa bathing equipment 1900. The remote diagnosis system 100 comprises a spa bathing system 1000, a remote operating platform 4000, an internetiintranet storage equipment 2420, and an external storage 2410. The internet/intranet storage equipment 2420 and the external storage 2410 are linked with a dashed line, which means that they are selectively disposed according to request. The spa bathing system 1000, the remote operating platform 4000, the internet/intranet storage equipment 2420, and the external storage 2410 are connected with each other by internet and/or intranet.

The spa bathing system 1000 comprises a plurality of devices 3100, a spa bathing control unit 2000, at least one spa bathing equipment 1900 (only one is shown, but is not limited thereto), and a power source 1400. The plurality of devices 3100 are used to actuate relatively to the spa bathing equipment 1900. In detail, the remote operating platform 4000 is connected with the spa bathing control unit 2000 through wired or wireless connection. The wireless connection comprises a direct connection with WIFI or an indirect connection with a router.

In detail, the plurality of devices 3100 comprise at least one attached device 3200, a light controller 3220, and a panel 2400. The at least one attached device 3200 is used to actuate relatively to the spa bathing equipment 1900, the at least one partial-region status comprises a working status of the at least one attached device 3200, the at least one partial-region information comprises a working information of the at least one attached device 3200. The power source 1400 is used to supply power for operating the spa bathing system 1000.

The spa bathing control unit 2000 comprises a control unit 2100 and a detection feedback device 2200. The control unit 2100 is used to control actuation of the plurality of devices 3100 and correspondingly generates at least one partial-region information according to at least one partial-region status generated by the spa bathing system 1000, to actively or passively transmit the at least one partial-region information toward outside the spa bathing system, the at least one partial-region information is different from a total input power information of the whole spa bathing system 1000. In detail, the at least one partial-region information is an information which is generated by corresponding single one or multiple of the plurality of devices 3100. The control unit 2100 is used to control the at least one attached device 3200, and then to control a working status of the at least one attached device 3200.

The detection feedback device 2200 is electrically connected with the control unit 2100 and the at least one attached device 3200. The detection feedback device 2200 comprises at least one sensor 2220 and at least one switch 2230 controlled by the control unit 2100. The at least one sensor 2220 is used to detect either a physical measurement value or a chemical measurement value, with reference to the at least one attached device 3200, to make that the at least one partial-region information contains either the physical measurement value or the chemical measurement value, with reference to the at least one attached device 3200.

The at least one attached device 3200 comprises at least one or a combination of a heater 3230, an ozone generator, an ultraviolet light generator 3270, a pump 3280, and a blower 3210.

The remote operating platform 4000 comprises a storage device 4010 and a managing unit 4020, and a user operation interface 4040. The storage device 4010 is used to store at least one reference value and the at least one partial-region information. The managing unit 4020 is used to perform the automatic detection process of the single attached device and/or the automatic detection process of the multiple attached devices on the at least one attached device, directly based on the at least one reference value and the at least one partial-region information. The remote operating platform 4000 connects with the spa bathing control unit 2000 via a network unit 3000, to receive the at least one partial-region information. The remote operating platform 4000 comprises the user operation interface 4040 corresponding with the at least one partial-region information, to selectively generate at least one diagnosis control that makes the control unit 2100 to perform at least one automatic detection process on a single attached device 3200 and/or multiple attached devices 3200 of the plurality of devices 3100, according to the at least one selected diagnosis control.

For example, the remote operating platform 4000 is one of a pad, a mobile phone, a notebook, a desktop, a server, or any electronic device comprising a microprocessor. In other words, any device which is able to connect with the internet can be used to operate the remote diagnosis system 100.

Preferably, at least one of the external storage 2410, the internet/intranet storage equipment 2420, and the remote operating platform 4000 is used to store at least one of a result of the at least one automatic detection process and an identification code with reference to the at least one spa bathing equipment 1900.

In actual operation, the remote diagnosis system 100 is controlled by the user operation interface 4040.

Compared with the conventional art, the remote operating platform 4000 makes the control unit 2220 selectively perform at least one automatic detection process on a single attached device and/or multiple attached devices of the plurality of devices, directly based on the at least one partial-region information, to directly determine whether the spa bathing system 100 is abnormal; the technical issue of the conventional art can be eliminated.

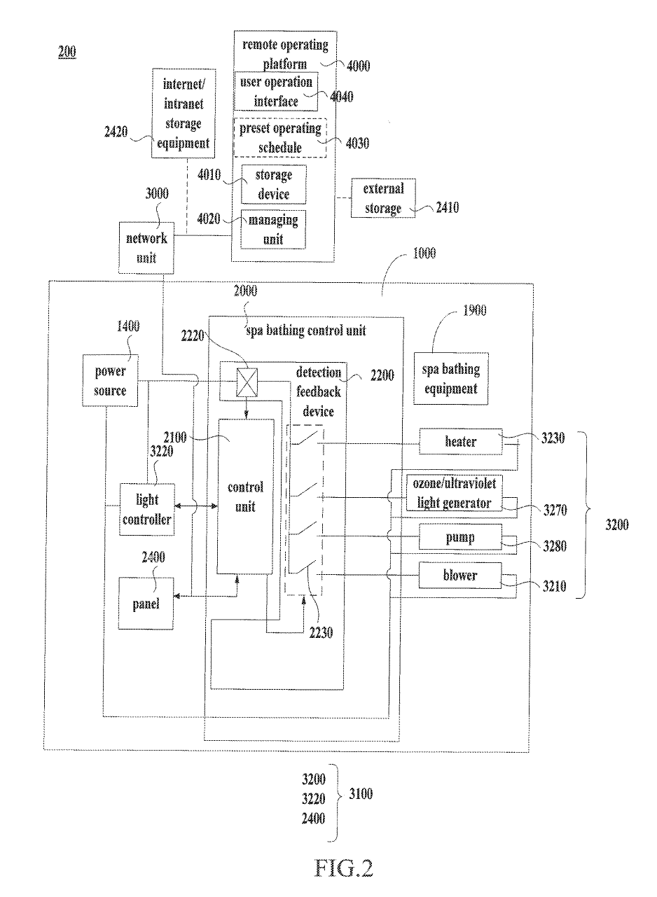

FIG. 2 is an architectural schematic view of a remote diagnosis system 200 according to a second preferred embodiment of the present invention. The difference between the second preferred embodiment and the first preferred embodiment is: the user operation interface 4040 is used to generate at least one preset operating schedule 4030, the at least one preset operating schedule 4030 comprises at least one diagnosis control. Hence, the remote operating platform 4000 is connected with the spa bathing control unit 2000, via the network unit 3000, to receive the at least one partial-region information, and performs the at least one preset operating schedule that makes the control unit 2100 to perform at least one automatic detection process on a single attached device 3200 and/or multiple attached devices 3200 of the plurality of devices 3100, according to the at least one diagnosis control.

Moreover, at least one of the external storage 2410, the interaet/intranet storage equipment 2420, and the remote operating platform 4000 is used to store at least one of a result of the at least one automatic detection process, an identification code with reference to the at least one spa bathing equipment 1900 and the at least one preset operating schedule.

In the preferred embodiment, the remote diagnosis system 200 receives at least one quest from a user (people use the spa bathing equipment 1900) and/or the at least one partial-region information collected daily, then, to perform the at least one automatic detection process according to the at least one preset operating schedule 4030 generated by the user operation interface 4040, in order to prevent the at least one automatic detection process being performed when the user is using the spa bathing equipment 1900.

In detail, the at least one preset operating schedule 4030 comprises a processing schedule and the automatic detection process, of the at least one spa bathing system: a format of the at least one preset operating schedule 4030 is one of a relational database, a non-relational databases, a text file, a spreadsheet, a format similar to the spreadsheet, and a computer-recognized data.

In actual operation, the remote diagnosis system 200 is operated according to the at least one preset operating schedule 4030.

In the second preferred embodiment, the user operation interface 4040 and the at least one preset operating schedule 4030 are included in the remote operating platform 4000; however, in other preferred embodiments, the user operation interface 4040 and the preset operating schedule 4030 can be in different remote operating platforms (not shown).

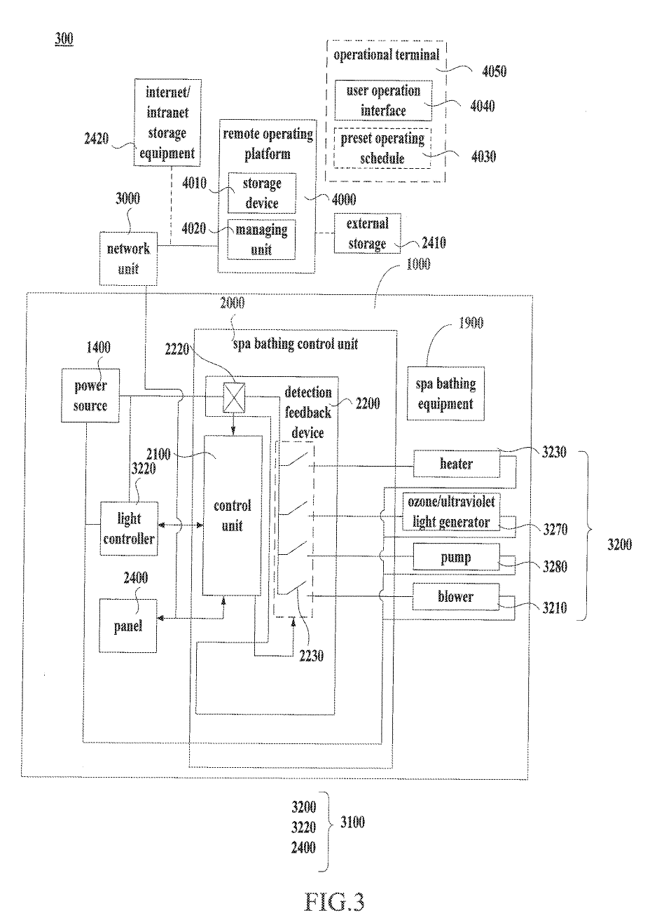

FIG. 3 is an architectural schematic view of a remote diagnosis system 300 according to a third preferred embodiment of the present invention. The difference between the third preferred embodiment and the second preferred embodiment is: the remote diagnosis system further comprises an operational terminal 4050, and the user operation interface is disposed in the operating terminal 4050. In detail, the remote operating platform 4000 is basically provided by the supplier of the spa bathing system 1000, user or the maintenance staff can operate remote diagnosis system 300 at the operating terminal 4050 and generate the at least one preset operating schedule 4030, then, make one or multiple spa bathing system 1000 be orderly performed the at least one automatic detection process according to the at least one preset operating schedule 4030.

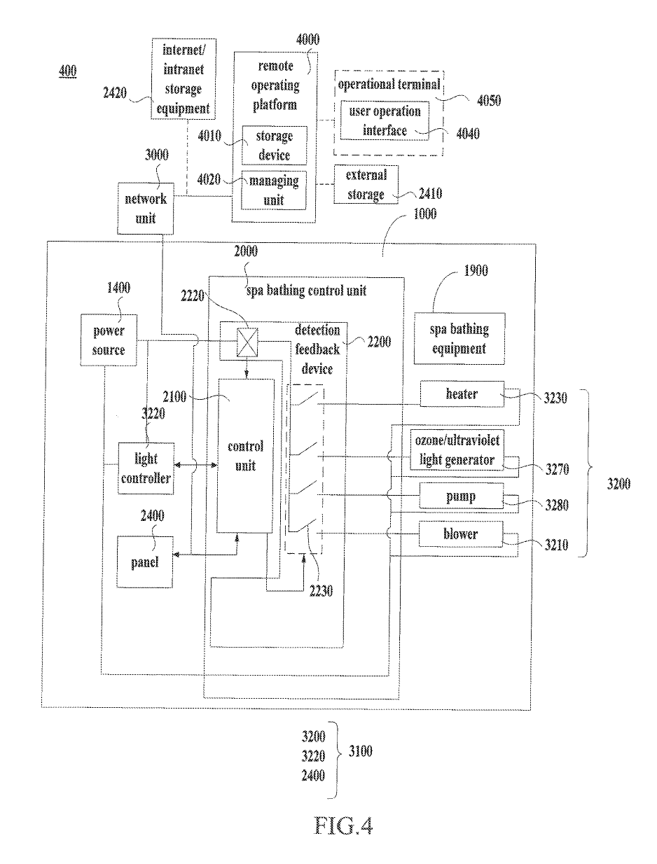

FIG. 4 is an architectural schematic view of a remote diagnosis system 400 according to a fourth preferred embodiment of the present invention. The difference between the fourth preferred embodiment and the third preferred embodiment is: there is not an at least one preset operating schedule 4030. In the preferred embodiment, the user operation interface 4040 is used to selectively generate at least one diagnosis control. The remote operating platform 4000 is connected with the spa bathing control unit 2000 via the network unit 3000, to make that the control unit 2100 is requested to perform at least one automatic detection process on a single attached device 3200 and/or multiple attached devices 3200 of the plurality of devices 3100, based on the at least one selected diagnosis control.

In the preferred embodiment, the user operation interface 4040 performs at least one automatic detection process according to the at least one diagnosis control of the spa bathing system 1000, to confirm that whether the spa bathing system 1000 is working normally or abnormally.

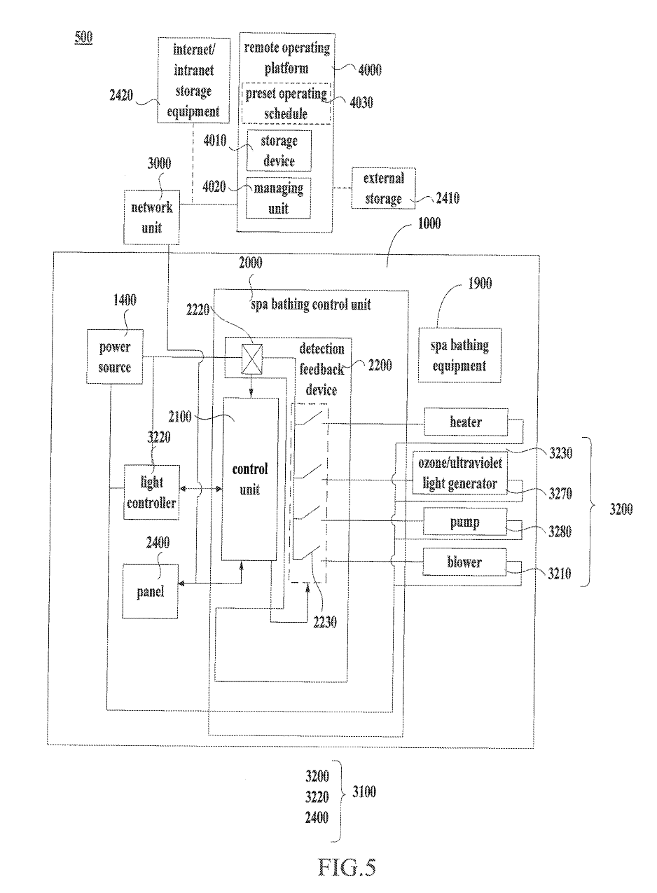

FIG. 5 is an architectural schematic view of a remote diagnosis system 500 according to a fifth preferred embodiment of the present invention. The difference between the fifth preferred embodiment and the first preferred embodiment is: there is the at least one preset operating schedule 4030 and no user operation interface 4040. In the preferred embodiment, the remote operating platform 4000 connects with the spa bathing control unit 2000 through the network unit 3000 and performs at least one preset operating schedule 4030, the at least one preset operating schedule 4030 contains at least one diagnosis control that makes the control unit 2100 to perform at least one automatic detection process on a single attached device 3200 and/or multiple attached devices 3200 of the plurality of devices 3100, based on the at least one diagnosis control.

In the preferred embodiment, the at least one preset operating schedule 4030 has been disposed in the remote operating platform 4000, hence, the remote diagnosis system 500 will perform the at least one automatic detection process on one or multiple spa bathing system 1000 according to the at least one preset operating schedule 4030.

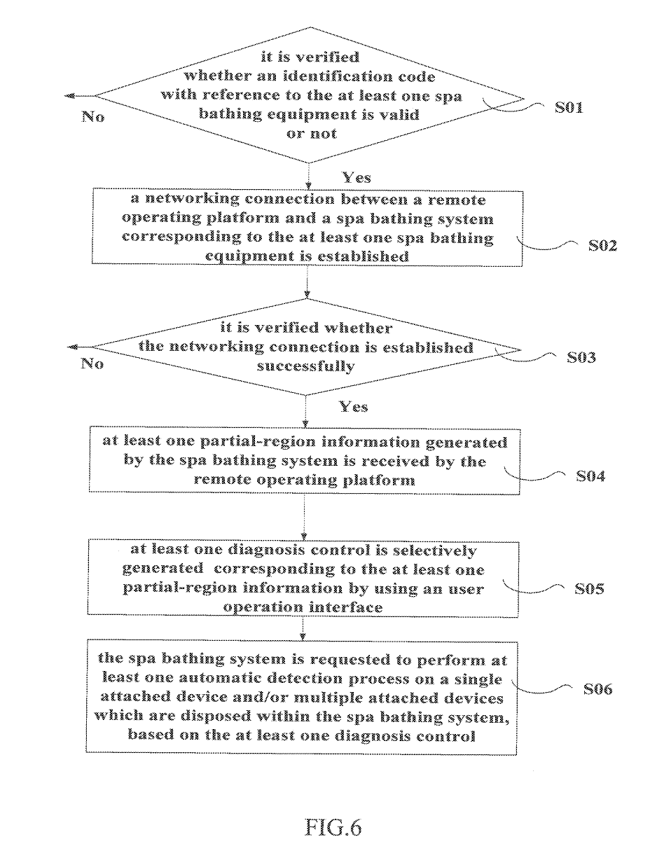

FIG. 6 is a flowchart of an operating method for a remote diagnosis system 100 according to a first preferred embodiment of the present invention. The elements of the method can be referred to the above preferred embodiments. First, performing step S01, it is verified whether an identification code with reference to the at least one spa bathing equipment 1900 is valid or not; if the identification code is not valid, the operation is ended; however, when the identification code is verified to be valid, performing step S02, a networking connection between a remote operating platform 4000 and a spa bathing system 1000 corresponding to the least one spa bathing equipment 1900 is established; then, performing step S03, it is verified whether the networking connection is established successfully. If the networking connection is established unsuccessfully, the operation is end; if the networking connection is established successfully, then, performing step S04, at least one partial-region information generated by the spa bathing system 1000 is received by the remote operating platform 4000; then, performing step S05, at least one diagnosis control is selectively generated by using a user operation interface 4040 corresponding to the at least one partial-region information; finally, performing step S06, the spa bathing system 1000 is requested to perform at least one automatic detection process on a single attached device 3200 and/or multiple attached device 3200 of the plurality of devices 3100 which are disposed within the spa bathing system 1000, based on the at least one diagnosis control.

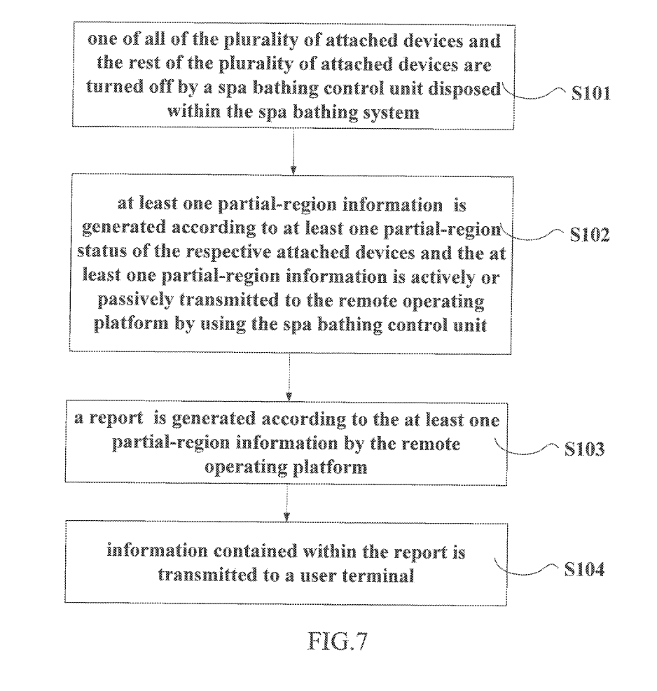

FIG. 7 is a detailed flowchart of the automatic detection process on the single attached device 3200 of FIG. 6. First, performing step 3101, one of all of the plurality of attached devices 3200 which are disposed within the spa bathing system 1000 is turned on and the rest of the plurality of the attached devices 3200 which are disposed within the spa bathing system 1000 are turned off by a spa bathing control unit 2000 which are disposed within the spa bathing system 1000; then, performing step S102, at least one partial-region information is generated according to at least one partial-region status of the respective attached devices 3200 and the at least one partial-region information is actively or passively transmitted to the remote operating platform 4000 by using the spa bathing control unit 2000; then, performing step S103, a report is generated according to the at least one partial-region information by the remote operating platform 4000; finally, performing step S104, information contained within the report is transmitted to a user terminal.

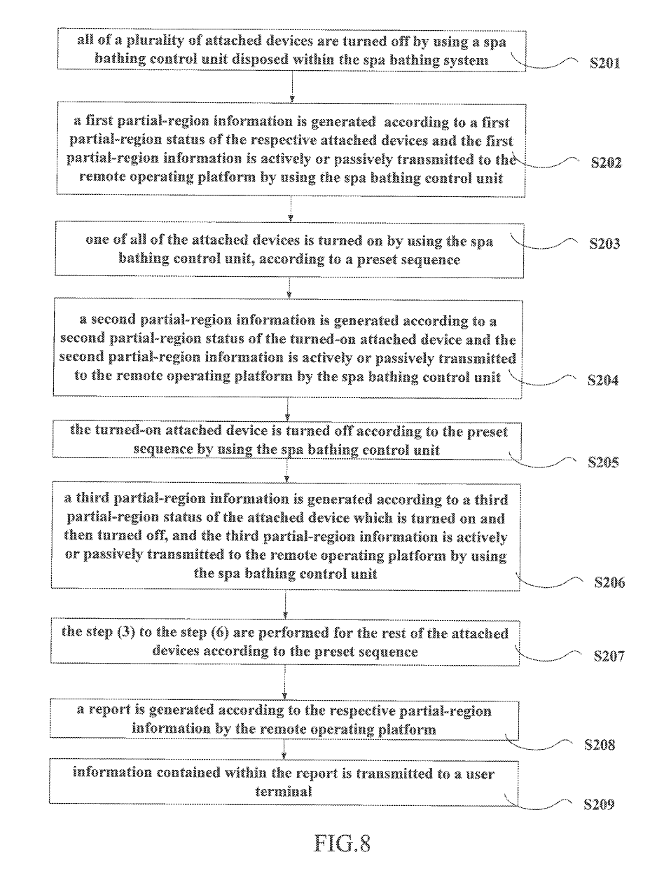

FIG. 8 is a detailed flowchart of the automatic detection process on the multiple attached devices 3200 of FIG. 6. First, performing step S201, all of a plurality of attached devices 3200 are turned off by using a spa bathing control unit 2000 disposed within the spa bathing system 1000; then, performing step S202, a first partial-region information is generated according to a first partial-region status of the respective attached devices 3200 and the first partial-region information is actively or passively transmitted to the remote operating platform 4000 by using the spa bathing control unit 2000 of the spa bathing system 1000; then, performing step 3203, one of all of the attached devices 3200 is turned on by using the spa bathing control unit 2000, according to a preset sequence; then, performing step S204, a second partial-region information is generated according to a second partial-region status of the turned-on attached device 3200 and the second partial-region information is actively or passively transmitted to the remote operating platform 4000 by the spa bathing control unit 2000; then, performing step S205, the turned-on attached device 3200 is turned off according to the preset sequence by using the spa bathing control unit 2000; then, performing step S206, a third partial-region information is generated according to a third partial-region status of the attached device 3200 which is turned on and then turned off, and the third partial-region information is actively or passively transmitted to the remote operating platform 4000 by using the spa bathing control unit 2000; then, performing step S207, the step S203 to the step S206 are performed for the rest of the attached devices 3200 according to the preset sequence; then, performing step S208, a report is generated according to the respective partial-region information by the remote operating platform 4000; finally, performing step S209, information contained within the report is transmitted to a user terminal,

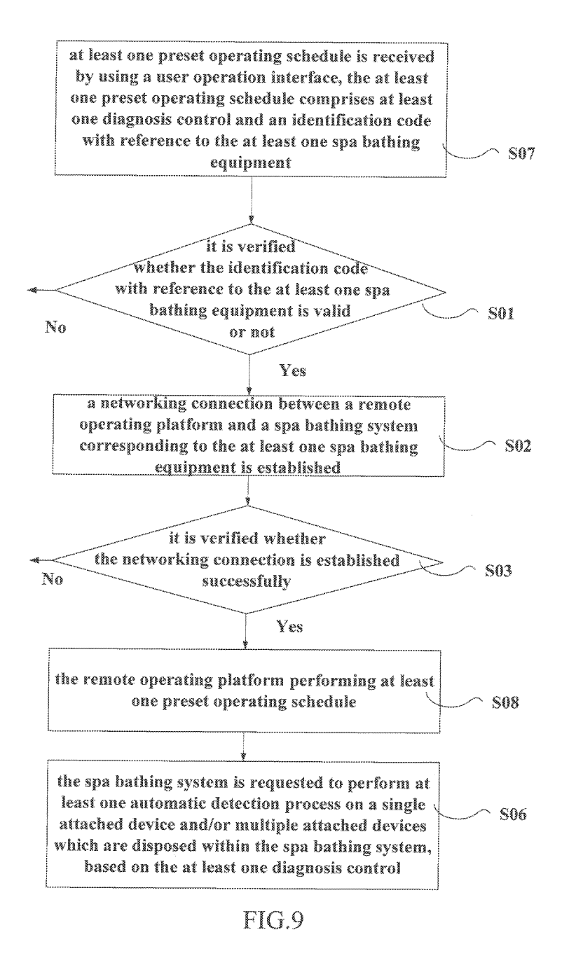

FIG. 9 is a flowchart of an operating method for a remote diagnosis system 200 according to a second preferred embodiment of the present invention. The elements of the method can be referred to the above preferred embodiments. The difference between the operating method of the second preferred embodiment and the operating method of the first preferred embodiment is: steps S07 and S08 are added, steps S04-S05 are deleted, First, performing step S07, at least one preset operating schedule 4030 is received by using a user operation interface 4040, the at least one preset operating schedule 4030 comprises at least one diagnosis control and an identification code with reference to the at least one spa bathing equipment 1900; then, performing step S01, it is verified whether an identification code with reference to the at least one spa bathing equipment 1900 is valid or not; if the identification code is not valid, the operation is ended; however, when the identification code is verified to be valid, performing step S02, a networking connection between a remote operating platform 4000 and a spa bathing system 1000 corresponding to the least one spa bathing equipment 1900 is established; then, performing step S03, it is verified whether the networking connection is established successfully. If the networking connection is established unsuccessfully, the operation is end; if the networking connection is established successfully, then, performing step S08, the remote operating platform 4000 performing at least one preset operating schedule 4030; finally, performing step S06, the spa bathing system 1000 is requested to perform at least one automatic detection process on a single attached device 3200 and/or multiple attached devices 3200 of the plurality of devices 3100 which are disposed within the spa bathing system 1000, based on the at least one diagnosis control. The operating method for at least one automatic detection process on the single attached device 3200 and/or the multiple attached devices 3200 which are disposed within the spa bathing system can be referred to the first preferred embodiment.

As described above, although the present invention has been described with the preferred embodiments thereof, those skilled in the art will appreciate that various modifications, additions, and substitutions are possible, without departing from the scope and the spirit of the invention, Accordingly, the scope of the present invention is intended to be defined only by reference to the claims.

What is claimed is:

1. A remote diagnosis system, which is applied to at least one spa bathing equipment, the remote diagnosis system comprising:
a spa bathing system, comprising
a plurality of devices, used to actuate relatively to the spa bathing equipment; and
a spa bathing control unit, comprising a control unit that is used to control actuations of the plurality of devices, correspondingly generate at least one partial-region information according to at least one partial-region status generated by the spa bathing system, and actively or passively transmit the at least one partial-region information toward outside the spa bathing system; and
a remote operating platform connected with the spa bathing control unit to receive the at least one partial-region information via a network unit, comprising a user operation interface used to correspond with the at least one partial-region information to selectively generate at least one diagnosis control that makes the control unit to perform at least one automatic detection process on a single attached device and/or multiple attached devices included within the plurality of devices, based on the at least one selected diagnosis control.

2. The remote diagnosis system according to claim 1, wherein the remote operating platform is one of a pad, a mobile phone, a notebook, a desktop, a server, or any electronic device having a microprocessor.

3. The remote diagnosis system according to claim 1, wherein the plurality of devices comprises at least one attached device, which performs actuations relative to the spa bathing equipment, the at least one partial-region status contains a working status of the at least one attached device, and the at least one partial-region information contains a working information of the at least one attached device.

4. The remote diagnosis system according to claim 3, wherein the control unit is used to control the at least one attached device, for further controlling the working status of the at least one attached device,

5. The remote diagnosis system according to claim 3, wherein the plurality of devices further comprises at least one sensor which is electrically connected with the control unit and is used to detect either a physical measurement value or a chemical measurement value with reference to the at least one attached device, to make that the at least one partial-region information contains either the physical measurement value or the chemical measurement value, with reference to the at least one attached device.

6. The remote diagnosis system according to claim 3, wherein the remote operating platform makes the control unit selectively performing the automatic detection process of the single attached device and/or the automatic detection process of the multiple attached devices on the at least one attached device, directly based on the at least one partial-region information.

7. The remote diagnosis system according to claim 3, wherein the spa bathing control unit further comprises a detection feedback device, which is used to be electrically connected with the control unit and the at least one attached device, the detection feedback device further comprises at least one sensor and at least one switch controlled by the control unit, the at least one sensor is used to detect either a physical measurement value or a chemical measurement value with reference to the at least one attached device, to make that the at least one partial-region information contains either the physical measurement value or the chemical measurement value, with reference to the at least one attached device.

8. The remote diagnosis system according to claim 7, wherein the remote operating platform make the control unit and the detection feedback device selectively performing the automatic detection process of the single attached device and/or the automatic detection process of the multiple attached device on the at least one attached device, directly based on the at least one partial-region information.

9. The remote diagnosis system according to claim 1, wherein the spa bathing system further comprises a power source, which is used to supply power for operation of the spa bathing system.

10. The remote diagnosis system according to claim 1, wherein the plurality of devices further comprise a light controller,

11. The remote diagnosis system according to claim 3, wherein the at least one attached device comprises at least one or a combination of a heater, an ozone generator, an ultraviolet light generator, a pump, and a blower,

12. The remote diagnosis system according to claim 1, wherein the remote operating platform further comprises:
a storage device, which is used to store at least one reference value and the at least one partial-region information; and
a managing unit, which is used to perform the automatic detection process of the single attached device and/or the automatic detection process of the multiple attached devices, directly based on the at least one reference value and the at least one partial-region information.

13. The remote diagnosis system according to claim 3, wherein the remote diagnosis system further comprises an external storage and/or an internet/intranet storage equipment.

14. The remote diagnosis system according to claim 13, wherein at least one of the external storage, the internet/intranet storage equipment and the remote operating platform is used to store at least one of a result of the at least one automatic detection process and an identification code corresponding to the at least one spa bathing equipment.

15. The remote diagnosis system according to claim 1, wherein the control unit correspondingly generates the at least one partial-region information, according to the at least one partial-region status generated by at least one of the plurality of devices and/or the spa bathing control unit, the at least one partial-region information is different from an information based on an input power supplied for the whole spa bathing system.

16. The remote diagnosis system according to claim 1, wherein the remote operating platform is connected with the spa bathing control unit through wired or wireless connection.

17. A remote diagnosis system, which is applied to at least one spa bathing equipment, the remote diagnosis system comprising:
at least one spa bathing system each of which comprises:
a plurality of devices used to actuate relatively to the spa bathing equipment; and
a spa bathing control unit, comprising a control unit which is used to control actuations of the plurality of devices, correspondingly generate at least one partial-region information according to at least one partial-region status generated by the spa bathing system, and actively or passively transmit the at least one partial-region information toward outside the spa bathing system;
a user operation interface, used to generate at least one preset operating schedule that comprises at least one diagnosis control; and
a remote operating platform connected with the spa bathing control unit to receive the at least one partial-region information via a network unit, performing the at least one preset operating schedule wherein the control unit is requested to perform at least one automatic detection process on a single attached device and/or multiple attached devices included within the plurality of devices, based on the at least one diagnosis control.

18. The remote diagnosis system according to claim 17, wherein the remote operating platform is one of a pad, a mobile phone, a notebook, a desktop, a server, or any electronic device comprising a microprocessor,

19. The remote diagnosis system according to claim 17, wherein the plurality of devices comprises at least one attached device, which perform actuations relatively to the spa bathing equipment, the at least one partial-region status contains a working status of the at least one attached device, and the at least one partial-region information contains a working information of the at least one attached device.

20. The remote diagnosis system according to claim 19, wherein the control unit is used to control the at least one attached device, for further controlling the working status of the at least one attached device.

21. The remote diagnosis system according to claim 19, wherein the plurality of devices further comprises at least one sensor which is electrically connected with the control unit and is used to detect either a physical measurement value or a chemical measurement value with reference to the at least one attached device, to make that the at least one partial-region information contains either the physical measurement value or the chemical measurement value with reference to the at least one attached device.

22. The remote diagnosis system according to claim 19, wherein the remote operating platform makes the control unit selectively performing the automatic detection process of the single attached device and/or the automatic detection process of the multiple attached device on the at least one attached device, directly based on the at least one partial-region information.

23. The remote diagnosis system according to claim 19, wherein the spa bathing control unit further comprises a detection feedback device which is electrically connected with the control unit and the at least one attached device, and the detection feedback device comprises at least one sensor and at least one switch controlled by the control unit, the at least one sensor is used to detect either a physical measurement value or a chemical measurement value with reference to the at least one attached device, to make that the at least one partial-region information contains either the physical measurement value or the chemical measurement value with reference to the at least one attached device.

24. The remote diagnosis system according to claim 23, wherein the remote operating platform make the control unit and the detection feedback device selectively performing the automatic detection process of the single attached device and/or the automatic detection process of the multiple attached device on the at least one attached device, directly based on the at least one partial-region information.

25. The remote diagnosis system according to claim 17, wherein the spa bathing system further comprises a power source which is used to supply power for operation of the spa bathing system.

26. The remote diagnosis system according to claim 20, wherein the plurality of devices further comprise a light controller.

27. The remote diagnosis system according to claim 19, wherein the at least one attached device comprises at least one or a combination of a heater, an ozone generator, an ultraviolet light generator, a pump, and a blower.

28. The remote diagnosis system according to claim 17, wherein the remote operating platform further comprises:
a storage device, which is used to store at least one reference value and the at least one partial-region information; and
a managing unit, which is used to perform the automatic detection process of the single attached device and/or the automatic detection process of the multiple attached devices, directly based on the at least one reference value and the at least one partial-region information.

29. The remote diagnosis system according to claim 17, wherein the remote diagnosis system further comprises an external storage and/or an internet/intranet storage equipment.

30. The remote diagnosis system according to claim 29, wherein at least one of the external storage, the intemet/intranet storage equipment, and the remote operating platform is used to store at least one of a result of the at least one automatic detection process, an identification code corresponding with the at least one spa bathing equipment, and the at least one preset operating schedule,

31. The remote diagnosis system according to claim 17, wherein the control unit correspondingly generates the at least one partial-region information, according to the at least one partial-region status of the at least one device of the plurality of devices and/or the spa bathing control unit, the at least one partial-region information is different from an information based on an input power supplied for the whole spa bathing system.

32. The remote diagnosis system according to claim 17, wherein the remote operating platform is connected with the spa bathing control unit through wired or wireless connection.

33. The remote diagnosis system according to claim 17, wherein the at least one preset operating schedule contains a processing schedule and the automatic detection process, of the at least one spa bathing system.

34. The remote diagnosis system according to claim 17, wherein a format of the at least one preset operating schedule is one of a relational database, a non-relational databases, a text file, a spreadsheet, a format similar to the spreadsheet, and a computer-recognized data.

35. The remote diagnosis system according to claim 17, wherein the remote diagnosis system further comprises an operational terminal, which is connected with the remote operating platform through wired or wireless connection, and the user operation interface is disposed on the operating terminal.

36. The remote diagnosis system according to claim 17, wherein the user operation interface is disposed on the remote operating platform.

37. A remote diagnosis system, which is applied to at least one spa bathing equipment, the remote diagnosis system comprising:
a spa bathing system, comprising
a plurality of devices, used to actuate relatively to the spa bathing equipment; and
a spa bathing control unit, comprising a control unit which is used to control actuations of the plurality of devices;
a user operation interface used to selectively generate at least one diagnosis control; and
a remote operating platform connected with the spa bathing control unit via a network unit, making the control unit to perform at least one automatic detection process on a single attached device and/or multiple attached devices included within the plurality of devices, based on the at least one diagnosis control.

38. The remote diagnosis system according to claim 37, wherein the control unit is used to correspondingly generate at least one partial-region information according to at least one partial-region status generated by the spa bathing system, and actively or passively transmit the at least one partial-region information toward outside the spa bathing system.

39. A remote diagnosis system, which is applied to at least one spa bathing equipment, the remote diagnosis system comprising:
at least one spa bathing system, each spa bathing system comprising
a plurality of devices, used to actuate relatively to the spa bathing equipment; and
a spa bathing control unit comprising a control unit which is used to control actuations of the plurality of devices; and
a remote operating platform, connected with the spa bathing control unit via a network unit, performing at least one preset operating schedule which contains at least one diagnosis control that makes the control unit to perform at least one automatic detection process on a single attached device and/or multiple attached devices included within the plurality of devices, based on the at least one diagnosis control.

40. An operating method for a remote diagnosis system, which is applied to at least one spa bathing equipment, the operating method comprising:
verifying whether an identification code with reference to the at least one spa bathing equipment is valid or not;
establishing a networking connection between a remote operating platform and a spa bathing system corresponding to the at least one spa bathing equipment when the identification code is verified to be valid;
the remote operating platform receiving at least one partial-region information generated by the spa bathing system when the networking connection is successfully established;
using a user operation interface corresponding to the at least one partial-region information selectively generating at least one diagnosis control; and
based on the at least one diagnosis control, the spa bathing system performing at least one automatic detection process on a single attached device and/or multiple attached devices which are disposed within the spa bathing system.

41. The operating method for a remote diagnosis system according to claim 40, wherein the automatic detection process performed on the single attached device comprises:
using a spa bathing control unit disposed within the spa bathing system to turn on one of all of the plurality of attached devices, and to turn off the rest of the plurality of attached devices;
using the spa bathing control unit to correspondingly generate at least one partial-region information according to at least one partial-region status of the respective attached devices, and to actively or passively transmit the at least one partial-region information to the remote operating platform; and
the remote operating platform generating a report according to the at least one partial-region information.

42. The operating method for a remote diagnosis system according to claim 41, further comprising:
transmitting information contained within the report to a user terminal.

43. The operating method for a remote diagnosis system according to claim 40, wherein the automatic detection process performed on the multiple attached devices comprises:
in step (1), using a spa bathing control unit disposed within the spa bathing system to turn off all of a plurality of attached devices;
in step (2), using the spa bathing control unit to correspondingly generate a first partial-region information according to a first partial-region status of the respective attached devices, and to actively or passively transmit the first partial-region information to the remote operating platform;
in step (3), using the spa bathing control unit to turn on one of all of the plurality of attached devices, according to a preset sequence;
in step (4), using the spa bathing control unit to correspondingly generate a second partial-region information according to a second partial-region status of the turned-on attached device, and to actively or passively transmit the second partial-region information to the remote operating platform;
in step (5), using the spa bathing control unit to turn off the turned-on attached devices, according to the preset sequence;
in step (6), using the spa bathing control unit to correspondingly generate a third partial-region information according to a third partial-region status of the attached device which is turned on and then turned off, and to actively or passively transmit the third partial-region information to the remote operating platform;
In step (7), performing the step (3) to the step (6) for the rest of the plurality of attached devices, according to the preset sequence; and
In step (8), the remote operating platform generating a report according to the respective partial-region information.

44. The operating method for a remote diagnosis system according to claim 43, further comprising:
transmitting information contained within the report to a user terminal.

45. An operating method for a remote diagnosis system, which is applied to at least one spa bathing equipment, the operating method comprising:
using a user operation interface receiving at least one preset operating schedule which comprises at least one diagnosis control and an identification code with reference to the at least one spa bathing equipment;
verifying whether the identification code is valid or not;
when the identification code is verified to be valid, establishing a networking connection between a remote operating platform and a spa bathing system corresponding to the at least one spa bathing equipment;
when the networking connection is established successfully, the remote operating platform performing at least one preset operating schedule; and
based on the at least one diagnosis control, making the spa bathing system performing at least one automatic detection process on a single attached device and/or multiple attached devices which are disposed within the spa bathing system.

46. The operating method for a remote diagnosis system according to claim 45, wherein the automatic detection process performed on the single attached device comprises:
using a spa bathing control unit disposed within the spa bathing system to turn on one of all of the plurality of attached devices, and to turn off the rest of the plurality of attached devices;
using the spa bathing control unit to correspondingly generate at least one partial-region information according to at least one partial-region status of the respective attached devices, and to actively or passively transmit the at least one partial-region information to the remote operating platform; and
the remote operating platform generating a report according to the at least one partial-region information.

47. The operating method for a remote diagnosis system according to claim 46, further comprises:
transmitting information contained within the report to a user terminal.

48. The operating method for a remote diagnosis system according to claim 45, wherein the automatic detection process performed on the multiple attached devices comprises:
In step (1), using a spa bathing control unit disposed within the spa bathing system to turn off all of the plurality of attached devices;
In step (2), using the spa bathing control unit to correspondingly generate a first partial-region information according to a first partial-region status of the respective attached devices, and to actively or passively transmit the first partial-region information to the remote operating platform;
In step (3), using the spa bathing control unit to turn on one of ail of the plurality of attached devices, according to a preset sequence;
In step (4), using the spa bathing control unit to correspondingly generate a second partial-region information according to the second partial-region status of the turned-on attached device, and to actively or passively transmit the second partial-region information to the remote operating platform;
In step (5), using the spa bathing control unit to turn off the turned-on attached devices, according to the preset sequence;
In step (6), using the spa bathing control unit to correspondingly generate a third partial-region information according to a third partial-region status of the attached device which is turned on and then turned off, and to actively or passively transmit the third partial-region information to the remote operating platform:
In step (7), performing the step (3) to the step (6) for the rest of the plurality of attached devices according to the preset sequence; and
In step (8), the remote operating platform generating a report according to the respective partial-region information.

49. The operating method for a remote diagnosis system according to claim 48, further comprises:
transmitting information contained within the report to a user terminal.
